(19) United States
(12) Patent Application Publication
(10) Pub. No.: US 2003/0216920 A1
(43) Pub. Date: Nov. 20, 2003

(54) Method and apparatus for processing number in a text to speech (TTS) application

(76) Inventor: Jianghua Bao, Bei Jing (CN)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 10/150,207

(22) Filed: May 16, 2002

(51) Int. Cl. G10L 13/08

(52) U.S. Cl. 704/260

(57) ABSTRACT

Methods for processing speech data are described herein. In one aspect of the invention, an exemplary method includes identifying a number from a text string received, parsing the number into magnitudes, matching each magnitude with a script from a database, and generating a voice output based on the script. Other methods and apparatuses are also described.

### FIELD OF THE INVENTION

The invention relates to speech recognition. More particularly, the invention relates to script design for a Mandarin limited domain text to speech (TTS) application in a speech recognition system.

### BACKGROUND OF THE INVENTION

Speech synthesis techniques are frequently used today in many applications. In many speech synthesis applications, it is desirable to provide smooth concatenation of the words in order to provide natural-sounding synthetic speech.

However, with some techniques, there is generally some spectral envelope mismatch at the concatenation boundaries. For severe cases, depending on the treatment of the signals, a signal may exhibit glitches or there may be degradation in the clarity of the speech. Consequently, a great deal of effort is often spent on choosing appropriate diphone units that will not have these defects irrespective of which other units they are matched with. Thus, in general, much effort is devoted to preparing a diphone set and selecting sequences that are suitable for recording and in verifying that the recordings are suitable for the diphone set.

Another approach to concatenative synthesis is to use a very large database for recorded speech that has been segmented and labeled with prosodic and spectral characteristics, such as the fundamental frequency (F0) for voiced speech, the energy or gain of the signal, and the spectral distribution of the signal (i.e., how much of the signal is present at any given frequency). The database contains multiple instances of speech sounds. This permits the possibility of having units in the database which are much less stylized than would occur in a diphone database where generally only one instance of any given diphone is assumed. Therefore, the possibility of achieving natural speech is enhanced.

Further, in concatenative speech synthesis, the coverage of the database is a key factor in influencing the quality of the synthesized speech. However, even for limited domains, it is difficult to cover the entire range of sounds. Further, an overly large database will result in slow, cumbersome, speech synthesis.

Speech synthesis of numbers is a limited domain text-to-speech (TTS) application that is useful for dates, phone numbers, etc. Although numbers are in a limited domain, the variety of sounds is nearly infinite. For example, the range of numbers necessary will require a large amount of sounds. Thus, it is important to have a TTS method that can satisfy a wide range of numbers with a limited database.

### BRIEF DESCRIPTION OF THE DRAWINGS

The present invention is illustrated by way of example and not limitation in the figures of the accompanying drawings in which like references indicate similar elements.

FIG. 1 shows a typical five main lexical tones used in Mandarin.

FIG. 2 shows a computer system which may be used according to one embodiment.

FIG. 3 shows a working flowchart used in one embodiment.

FIG. 4 shows a working flowchart used in an alternative embodiment.

FIG. 5 shows a working flowchart of yet an alternative embodiment.

FIG. 6 shows a method used in one embodiment of the invention.

### DETAILED DESCRIPTION

The following description and drawings are illustrative of the invention and are not to be construed as limiting the invention. Numerous specific details are described to provide a thorough understanding of the present invention. However, in certain instances, well-known or conventional details are not described in order to not unnecessarily obscure the present invention in detail.

Methods and apparatus' for speech synthesis of numbers of a language are disclosed. The subject of the invention will be described with reference to numerous details set forth below, and the accompanying drawings will illustrate the invention. The following description is illustrative of the invention and is not to be construed as limiting the invention. Numerous specific details are described to derive a thorough understanding of present invention. However, in certain circumstances, well known, or conventional details are not described in order not to obscure the present invention in detail.

Reference throughout this specification to “one embodiment”, “an embodiment”, or “preferred embodiment” indicates that a particular feature, structure, or characteristic described in connection with the embodiment is included in at least one embodiment of the present invention. Thus, the appearance of the phrase “in one embodiment”, “in an embodiment”, or “in a preferred embodiment” in various places throughout the specification are not necessarily all referring to the same embodiment. Furthermore, the particular features, structures, or characteristic may be combined in any suitable manner in one or more embodiments.

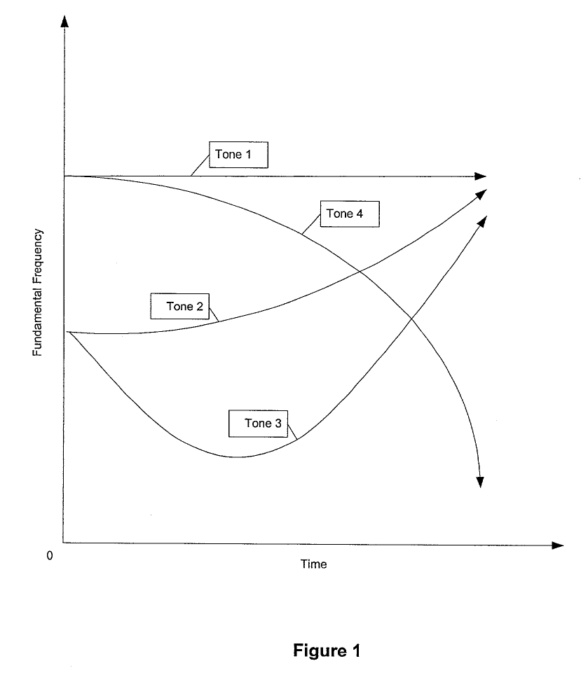

Unlike most European languages, Mandarin Chinese uses tones for lexical distinction. A tone occurs over the duration of a syllable. There are five main lexical tones that play very important roles in meaning disambiguation. FIG. 1 shows the typical five main lexical tones used in Mandarin. The direct acoustic representative of these tones is the pitch contour variation patterns, as illustrated in FIG. 1. In some cases, one word may have more than one meaning, when the word is associated with different lexical tone. As a result, there could be very large amount of meaning or voice outputs for every single word in Mandarin. Similarly, the voice outputs representing the number could be burdensome, in a text to speech (TTS) application. As the computer system is getting more popular, it is apparent to a person with ordinary skill in the art to use a computer system to implement such application.

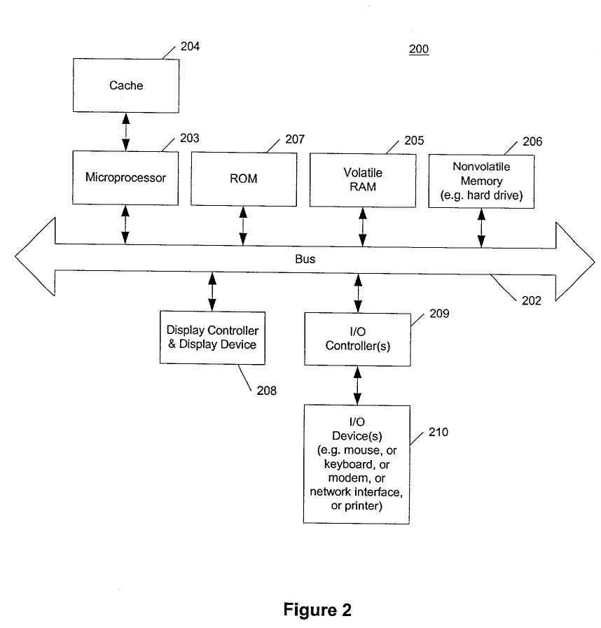

FIG. 2 shows one example of a typical computer system, which may be used with one embodiment of the invention. Note that while FIG. 2 illustrates various components of a computer system, it is not intended to represent any particular architecture or manner of interconnecting the components, as such details are not germane to the present invention. It will also be appreciated that network computers and other data processing systems which have fewer components or perhaps more components may also be used with the present invention. The computer system of FIG. 2 may, for example, be an Apple Macintosh or an IBM compatible computer.

As shown in FIG. 2, the computer system 200, which is a form of a data processing system, includes a bus 202 which is coupled to a microprocessor 203 and a ROM 207 and volatile RAM 205 and a non-volatile memory 206. The microprocessor 203 is coupled to cache memory 204 as shown in the example of FIG. 2. The bus 202 interconnects these various components together and also interconnects these components 203, 207, 205, and 206 to a display controller and display device 208 and to peripheral devices such as input/output (I/O) devices, which may be mice, keyboards, modems, network interfaces, printers and other devices which are well known in the art. Typically, the input/output devices 210 are coupled to the system through input/output controllers 209. The volatile RAM 205 is typically implemented as dynamic RAM (DRAM) which requires power continuously in order to refresh or maintain the data in the memory. The non-volatile memory 206 is typically a magnetic hard drive, a magnetic optical drive, an optical drive, a DVD RAM, or other type of memory system which maintains data even after power is removed from the system. Typically, the non-volatile memory will also be a random access memory, although this is not required. While FIG. 2 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 202 may include one or more buses connected to each other through various bridges, controllers, and/or adapters, as is well-known in the art. In one embodiment, the I/O controller 209 includes a USB (Universal Serial Bus) adapter for controlling USB peripherals.

In current text to speech (TTS) technology, the size of the speech database is an important factor influencing the quality of the generated speech. Generally speaking, assuming a good selection method is adopted, the larger the speech database, the more natural sounding the generated speech will be. However, there is a trade off with the size of the speech database. As the size of the speech database increases, this will occupy more storage, as well as requiring greater processing power to generate real time synthesis of speech. Therefore, it is desirable to balance between (1) a reasonable size of the speech database to produce an acceptable quality of speech and (2) the problems introduced by large database sizes.

A number reader is essentially a limited TTS application that can be used to read any number that may occur in text. Although it is only a number domain, the variety of speech is still quite large. For example, if one thinks of all the possible numbers, there is tremendous variation. First, the number itself can be countless, ranging from zero to infinite. Further, fractional decimal numbers after a decimal point cause additional variation.

The present invention relates to a TTS method for converting numbers into Mandarin speech. There is a presumption that a person reading a long series of numbers will have breathing breaks that are nearly unperceivable. The breathing breaks are typically at large “magnitudes”. For example, the number 10,135 is typically read as “ten thousand (break) one hundred (break) thirty-five”. This presumption leads to the script design of an embodiment of the present invention.

The script design generally converts each magnitude or number most frequently used in a plurality of scripts. Then the scripts are used to construct the final voice output based on the numbers and their magnitudes. Under this presumption, a method of an embodiment of the present invention is optimized to cover all of the possible magnitude units, like “1000”, “100”, prefixed with all the possible numbers between magnitudes.

In Mandarin Chinese, there are five basic magnitude units. They are equivalent to “100,000,000”, “10,000”, “1,000”, “100”, and “10”. Recently, there is an additional magnitude corresponding to “1,000,000” that has gained in popularity. These six magnitudes can combine with each other to form new magnitudes. For example, the magnitudes “10” and “100,000,000” may be combined to give a magnitude of “1,000,000,000”.

In typical English speech, a zero is not read in the middle of a number except after a decimal point. However, in Mandarin, when there is a jump of two magnitudes of order, such as like between hundreds and ten-thousands, for example the number “40126”, the zero in the middle is always read out.

There are also various special language phenomena that need to be taken into consideration for Mandarin. However, it is easy to list all of the possible segments that need to be covered in the TTS engine. These segments may be produced by combining all of the magnitudes mentioned above with the ten digits from one through ten. Thus, the entire possible segment lists for numbers are included in the database.

Moreover, in an alternative embodiment, all of the numbers between zero and ninety-nine are included in the database. In doing so, the most frequently occurring numbers are included in the database and those corresponding segment lists may be used either occurring alone or inside a larger number.

With respect to numbers that should be read as a sequence of digits rather than a number, for example a phone number, a different script design is used. Since all of these numbers are handled as a series of digital numbers, this is handled by a segment list that covers all of the digits zero through nine.

Furthermore, according to the present invention, the script design uses a “look ahead” feature to ascertain the context of the text. For example, the “context” refers to the immediately preceding left digit and the immediately following right digit including the silence indicating a left context of the beginning digits or the right context of the final digits. Therefore, counting all of the combinations, there are proximately 1200 results that need to be covered in the script design. In the preferred embodiment, the candidates were selected from all of the 10,000 four digit numbers rather than three digit numbers or five digit numbers. However, in alternative embodiments, the candidates may be chosen from all numbers of varying digit length.

According to the present invention, it is surmised that the 10,000 four digit numbers, (e.g., 0001 to 9999), can adequately cover all of the 1200 combinations. Further, this takes into account that when people read a long independent digit string, the reader usually takes breathing breaks in the middle. The breathing breaks often occur at a minimum of every five digits. Since four digits is the longest possible group, it is advantages to use four digits rather than three digits.

One issue is the selection of the fewest number of four-digit numbers, but still cover all 1200 combinations. The specific implementation is referred to as a “greedy algorithm”. This algorithm cycles through each of the 10,000 four-digit numbers recursively. Each cycle only selects one four-digit number that can cover the most combinations in the 1200 possibilities. This four-digit number is then noted in memory and the covered combinations are also noted in memory so as to skip them at the next cycle. This selection continues until all of the 1200 combinations are covered.

In the Mandarin language, a special situation arises with respect to the digit “1”. For the digit “1”, there are two pronunciations: “yi” and “yao”. Both of these pronunciations are used for the numeral one. Thus, for the same numeral “1”, two transcriptions are needed in the script to cover the two pronunciations. Similarly, digit of “2” has two scripts of “er” and “liang”.

Similar to English, in Chinese, a decimal number is read as two parts separated by a decimal point. The part before the decimal point is read as an integer and the part after the decimal point is read as a sequence of digits. In an English example, the number “123.456” would be read: “one hundred twenty three point four five six”. A similar situation exists in Chinese. Therefore, the context of the decimal point should be covered. Only considering the digits before the decimal point and after the decimal point, there are a total of 100 variations by inserting the decimal point in the middle of all the two digits ranging from 0 to 99 (e.g., 0.0 to 9.9).

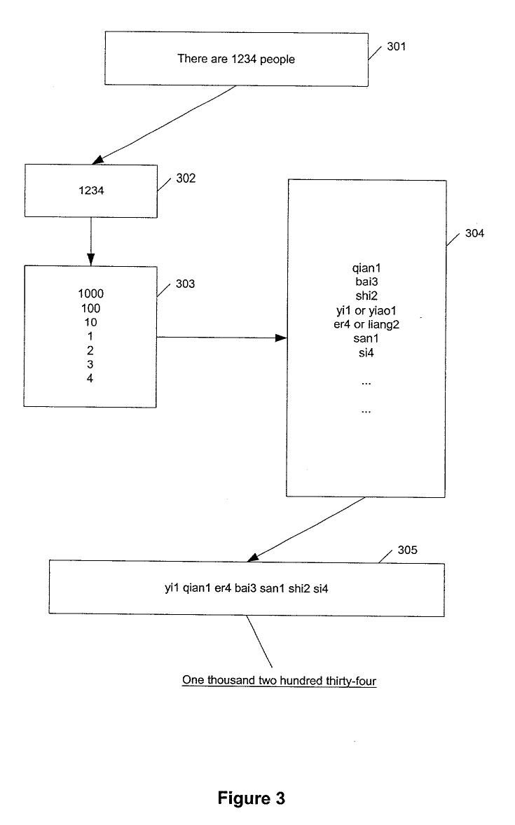

FIG. 3 shows an example of an embodiment of the present invention. Referring FIG. 3, the sentence 301 is inputted to the system. At this situation, the system detects that the number should be read as amount, such as one thousand two hundred thirty-four, based on the words of the sentence. Then the system identifies and extracts the number 302 out of the sentence. Based on the number 302, the system divides it into a plurality of sub number 303, as well as their magnitudes. The database 304 contains every possible combination of scripts corresponding to the number. For example, the magnitude of 1000 is “qian”. Wherein the “1” following “qian” is the Chinese tone as described in FIG. 1. Similarly, magnitude of 100 is “bai3”, etc. Next, the system matches the number and its magnitude with the scripts in the database 304. For example, magnitude of 1000 matches with script of “qian1” and number of 4 matches with script of “si4”. As a result, the voice output 305 is generated based on the scripts from the database 304. Although the database 304 is shown as single database, it would be appreciated that the database 304 could contain multiple databases. In one embodiment, wherein the system is a network computer, the database or databases 304 may be stored in a remote network storage device.

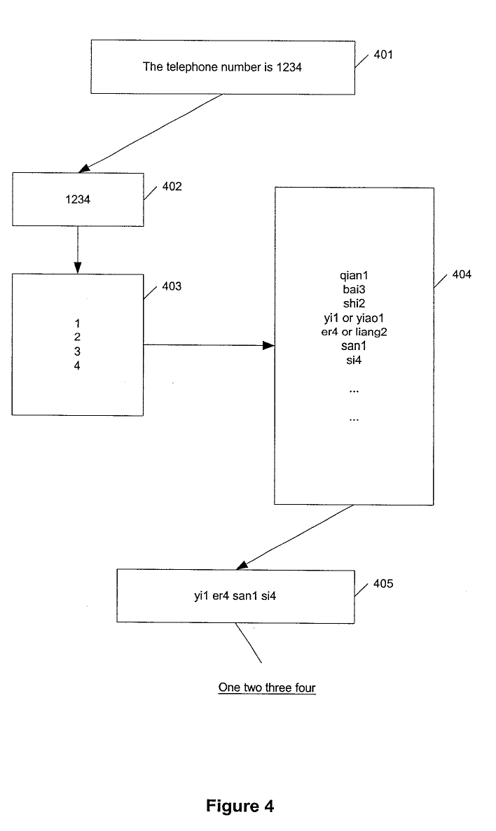

FIG. 4 shows an example of an embodiment of the present invention. Referring FIG. 4, the sentence 401 is inputted to the system. At this situation, the system detects that the number should be read as plain number, such as one two three four, based on the words of the sentence (e.g., telephone number). Then the system identifies and extracts the number 402 out of the sentence. Based on the number 402, the system divides it into a plurality of sub number 403, as well as their magnitudes. The database 404 contains every possible combination of scripts corresponding to the number. Next, the system matches the number with the scripts in the database 404. For example, the number of 1 matches with script of “yi1”. As a result, the voice output 405 is generated based on the scripts from the database 404. In this case, since the number is for telephone, there is no magnitude involved.

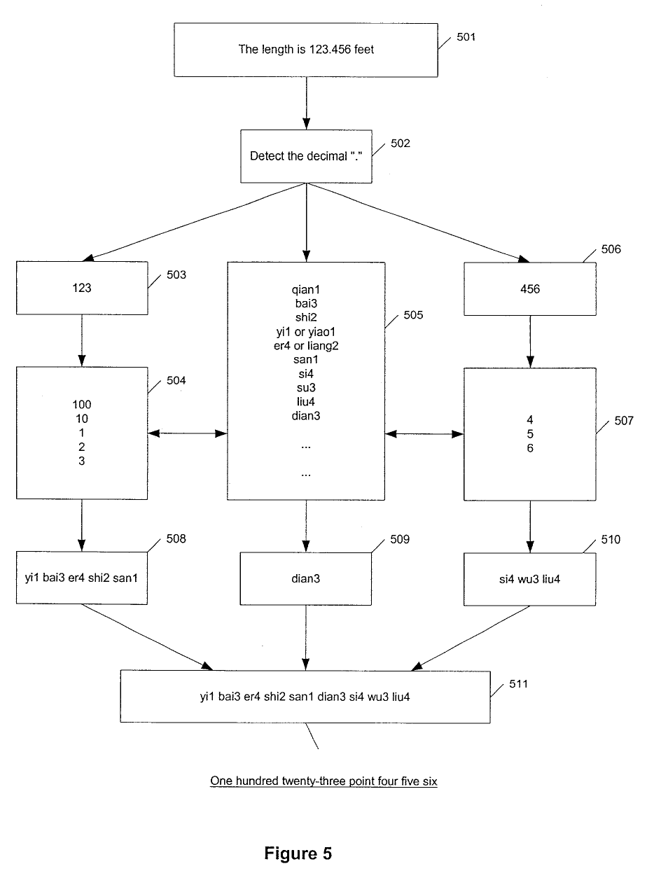

FIG. 5 shows another embodiment of the present invention, wherein the number contains a floating-point number. Referring to FIG. 5, the sentence 501 is inputted to the system. The system then detects the decimal point 502. Based on the decimal point, the system extracts the number preceding the decimal point as an integer 503. Then the sub numbers and their magnitudes 504 are derived from the integer 503. Next the system looks up the database 505 for their matched scripts and generates the voice output 508 for the integer 503. On the other hand, the numbers following the decimal point 502 are extracted as plain number 506. The number 506 then divided into sub numbers 507. The system then looks up the database 505 for their matched scripts and generates their corresponding voice output 510. The voice output 509 of the decimal point (e.g., dian3) is also generated from the database 505. Finally, all of the voice outputs are combined into final voice output 511 for the whole number of 123.456.

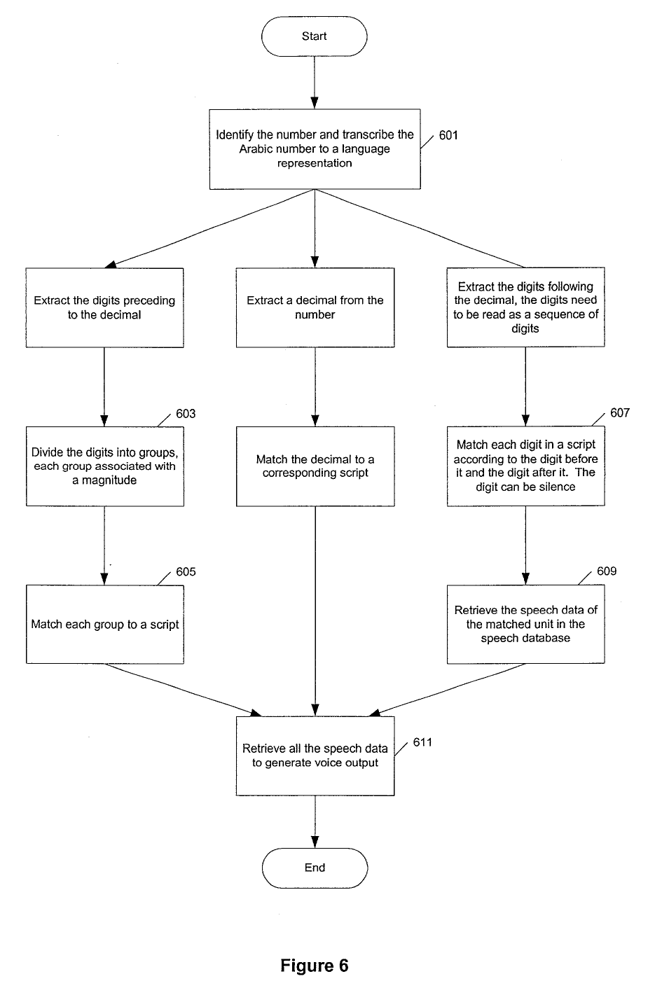

FIG. 6 shows a working flow of the number reader in accordance with the present invention is described. First, at step 601, the number to be read is identified in the text and parsed into three separate portions: the integer portion, the decimal point, and the fractional decimal after the decimal point. As an example, assume the number is “12345.789”. The integer portion would be “12345” and the fractional portion would be “0.789”.

At step 603, the integer portion is then divided into groups, each group corresponding to a magnitude. After the integer portion has been divided into groups, at step 605, each group is then matched with the phonetic sound in the script.

The fractional portion after the decimal point is a number that needs to be read as a sequence of digits. Therefore, at step 607, each digit in the fractional portion is matched to the script according to the digit previous to it and the digit after it. At step 609, the speech data from the database is then retrieved. Finally, at step 611, the integer portion is concatenated with the decimal point script followed by the fractional portion after the decimal point.

Although the present invention is described to be used in a Mandarin limited domain TTS application, it would be appreciated that the present invention may used in other language (e.g., English) limited domain TTS processing.

While specific embodiments of applications of the present invention have been illustrated and described, it is to be understood that the invention is not limited to the precise configuration and components disclosed herein. Various modifications, changes, and variations, which will be apparent to those skilled in the art, may be made in the arrangement, operation, in details of the methods and systems of the present invention disclosed herein without departing from the spirit and scope of the invention.

These modifications can be made to the invention in light of the above detailed description. The terms used in the following claims should not be used to limit the invention to the specific embodiments disclosed in the specification and the claims. Rather, the scope of the invention is to be determined entirely by the following claims, which are to be construed in accordance with established canons of claim interpretation.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method, comprising:
receiving a text string;
identifying a number in the text string;
parsing the number into magnitudes;
matching each magnitude with a script from a database; and
generating a voice output based on the script.

2. The method of claim 1, further comprising dividing the number into a plurality of groups, each of the plurality of groups being associated with a magnitude.

3. The method of claim 2, wherein each of the plurality of groups is matched with a corresponding script from the database.

4. The method of claim 1, wherein the database comprises multiple databases.

5. The method of claim 1, wherein the magnitudes comprises 100,000,000, 1,000,000, 10,000, 1000, 100, and 10.

6. The method of claim 1, further comprising transcribing the number into a language representation.

7. The method of claim 1, further comprising combining all the magnitudes to generate a candidate list corresponding to the number.

8. The method of claim 7, further comprising selecting four-digit numbers through a greedy algorithm.

9. The method of claim 1, wherein the database contains multiple scripts corresponding to a single digit.

10. The method of claim 1, further comprising examining the text string to determine whether the number should be read as an integer or as a sequence of digits.

11. The method of claim 10, further comprising:
if the number should be read as a sequence of digits, dividing the number into a plurality of single digits, and matching each of the plurality of the single digits into a corresponding script from the database.

12. The method of claim 1, further comprising detecting a starting digit and a ending digit of the number.

13. The method of claim 11, wherein the starting and ending digits are detected based on silence indicators preceding and following the digits.

14. A method, comprising:
identifying a number in a text string;
detecting a decimal of the number;
extracting first digits preceding the decimal;
parsing the first digits into magnitudes;
matching each magnitude with a script from a database; and
generating a first voice output based on the script.

15. The method of claim 14, further comprising:
extracting second digits following the decimal;
matching each of the second digits in the script according to the digits before and after;
retrieving the speech data of the matched unit in the database;
generating a second voice output based on the speech data; and
combining the first and second voice outputs to create a final voice output.

16. The method of claim 15, further comprising:
retrieving a script corresponding to the decimal from the database;
generating a third voice output based on the script corresponding to the decimal; and
combining the first, second and third voice outputs to generate the final voice output.

17. The method of claim 14, further comprising dividing the first digits into a plurality of groups, wherein each of the plurality of groups is associated with a magnitude.

18. The method of claim 17, wherein each of the plurality of groups is matched with a corresponding script from the database.

19. A machine-readable medium having stored thereon executable code which causes a machine to perform a method, the method comprising:
receiving a text string;
identifying a number in the text string;
parsing the number into magnitudes;
matching each magnitude with a script from a database; and
generating a voice output based on the script.

20. The machine-readable medium of claim 19, wherein the method further comprises dividing the number into a plurality of groups, each of the plurality of groups being associated with a magnitude.

21. The machine-readable medium of claim 19, wherein the method further comprises examining the text string to determine whether the number should be read as an integer or as a sequence of digits.

22. The machine-readable medium of claim 21, wherein the method further comprises:
if the number should be read as a sequence of digits, dividing the number into a plurality of single digits, and matching each of the plurality of the single digits into a corresponding script from the database.

23. A machine-readable medium having stored thereon executable code which causes a machine to perform a method, converting numeric text to speech, the method comprising:
identifying a number in a text string;
detecting a decimal of the number;
extracting first digits preceding the decimal;
parsing the first digits into magnitudes;
matching each magnitude with a script from a database; and
generating a first voice output based on the script.

24. The machine-readable medium of claim 23, wherein the method further comprises:
extracting second digits following the decimal;
matching each of the second digits in the script according to the digits before and after;
retrieving the speech data of the matched unit in the database;
generating a second voice output based on the speech data; and
combining the first and second voice outputs to create a final voice output.

25. The machine-readable medium of claim 24, wherein the method further comprises:
retrieving a script corresponding to the decimal from the database;
generating a third voice output based on the script corresponding to the decimal; and
combining the first, second and third voice outputs to generate the final voice output.

26. A system, comprising:
a first unit to receive and identify a number in a text string;
a second unit to parse the number into magnitudes;
a third unit to match each magnitude with a script from a database; and
a fourth unit to generate a voice output based on the script.

27. The system of claim 26, wherein the second unit divides the number into a plurality of groups, each of the plurality of groups being associated with a magnitude.

28. A system, comprising:
a first unit to identify a number in a text string;
a second unit to detect a decimal of the number;
a third unit to extract first digits preceding the decimal;
a fourth unit to parse the first digits into magnitudes;
a fifth unit to match each magnitude with a script from a database; and
a sixth unit to generate a first voice output based on the script.

29. The system of claim 28, wherein:
the third unit extracts second digits following the decimal;
the fifth unit matches each of the second digits in the script according to the digits before and after, and retrieves the speech data of the matched unit in the database; and
the sixth unit generates a second voice output based on the speech data, and combines the first and second voice outputs to create a final voice output.

30. The system of claim 29, wherein:
the fifth unit retrieves a script corresponding to the decimal from the database; and
the sixth unit generates a third voice output based on the script corresponding to the decimal, and combines the first, second and third voice outputs to generate the final voice output.
